(19) United States
(12) Patent Application Publication
(10) Pub. No.: US 2021/0103966 A1
(43) Pub. Date: Apr. 8, 2021

(54) RETAIL DRONE

(71) Applicant: Lujean J. CUMMINGS, Savannah, GA (US)

(72) Inventor: Lujean J. CUMMINGS, Savannah, GA (US)

(21) Appl. No.: 17/063,593

(22) Filed: Oct. 5, 2020

Related U.S. Application Data
(60) Provisional application No. 62/911,108, filed on Oct. 4, 2019.

(51) Int. Cl. G06Q 30/06; G06Q 10/08; G06Q 20/20; G06Q 30/00; G06K 7/14; B64C 39/02; B64D 47/08; G05D 1/10; H04N 7/18

(52) U.S. Cl. CPC G06Q 30/0613; B64C 2201/126; G06Q 20/203; G06Q 20/202; G06Q 20/209; G06Q 20/208; G06Q 30/0185; G06Q 30/0633; G06K 7/1413; B64C 39/024; B64D 47/08; G05D 1/106; G05D 1/104; H04N 7/185; B64C 2201/027; B64C 2201/127; G06Q 10/087

(57) ABSTRACT

A system for a point of sale transaction within a retail facility includes an aerial drone having a barcode scanner and printer capabilities, an onsite transaction application that can run on a handheld smart device, and a server/cloud transaction system that can act as a transaction system and an anti-theft system. A shopper can summon the aerial drone for a sales transaction or return, and using the drone scanner, list the items that are present in their shopping cart, which generates a physical or electronic listing of the items to be purchased or returned. The list can be presented to a clerk for payment, or the customer can present a debit/credit card at a kiosk portal to pay for their items electronically. The list is also transmitted to the cloud/sever as a record and used to manage inventory. The shopper has an assigned or preassigned identifier for use by the transaction system, e.g. the anti-theft system.

### FIELD OF THE INVENTION

The invention relates generally to the use of drones in retail shopping facilities to improve the efficiency of the operation and customer service/satisfaction, especially when customer volume is high.

### BACKGROUND OF THE INVENTION

According to trade publications, drones are finding their way into retail spaces. Drones assist with stock and inventory, security, identification of commercially important real estate, as well as assessing customer shopping behaviors and securing photographs of marketing significance.

Drones are dispatched to retrieve an item of inventory located within a retail shopping facility. The item is secured, placed in a receptacle, and then the drone is dispatched to a delivery area within the retail shopping facility where the customer is waiting. See PCT/US2016/051249.

Drones are also employed in conjunction with intelligent inventory systems. Modern enterprise warehouse management requires a large amount of manpower. In current warehouse inventory management, a warehouse manager holds a barcode reader or RFID device to scan RFID labels on goods, one by one. In CN 201811123464, a machine replaces the manual reading step. Consider also, US 20160247116.

Drones are also used in the retail space to recover a customer's layaway items. The layaway processing utility electronically stores the information about the layaway account, and communicates with the customer. The drone detects when the customer has entered the retail store, and communicates with the layaway processing unit. The drone is loaded with the layaway merchandise, and automatically finds and delivers the items placed on layaway to the customer in the retail store. The customer can interact with the layaway unit using a mobile computing unit to schedule the pickup and/or make payments. The layaway system reduces the wait time and minimizes employee time to find and deliver the layaway merchandise. See WO/2018/089588.

Drones are also able to provide shopping assistance and in-store navigation—“Intelligent Shopping Cart with Personalized Recommender System”. See IN 201841044312. The shopper can download the smart device application to a handheld smart device and use it to create a personal account, request shopping assistance within the store, and search for products within the store, as well as receive personalized recommendations and offers on products, manage online billing and payments, and allow the customer the option for self-checkout. The smart device application will be supported with vision based methods in order to avoid collisions with other drones. It provides an enhanced shopping experience for shoppers who utilize this application with their handheld smart devices. The drone is also equipped with an RFID reader module which can read RFID product tags from a distance.

### OBJECTS OF THE INVENTION

A variety of factors affect the retail shopping experience. The disclosed invention improves the shopping experience by addressing resource allocation and enhancing productivity and efficiency. The sales transaction is simplified and inventory management is rendered more current. A sales transaction can be finalized anywhere in the store and the inventory levels kept current with each sale or return. The system of the invention allows the customer (shopper) to summon a drone when shopping trip is concluded. Since the improved drone has both scanning and printing functions, the sales transaction can be concluded when the last item is placed in the shopping cart, no matter where the cart is located. The customer merely summons the drone using a hand gesture or their handheld smart device. The system of the invention does the rest all within the confines of a retail store.

The drone has the ability to scan the bar code of each item in the customer's cart. The items can be for purchase or returns. The drone prints a list or lists of the items in the cart. The drone can also optionally transmit the list or lists of items to a server or cloud via a transaction application. Since a prescribed area of the retail facility is not required for item returns or purchases, customer lines do not occur. Staff does not have to be summoned. The next available drone approaches the customer and cart. The number of available staff is not critical to the check out or return processes. The congestion associated with assigned areas for returns and purchases within the store is avoided. Even if these areas exist, the prior generation of purchase and return lists speeds up the process.

The improved drone having both the barcode scanner and printer ensure that two critical functions associated with retail purchases and returns can be efficiently transported to where they are needed, i.e. the customer having items in a shopping cart ready to check out or return items. The shopping data is readily conveyed to the system of the invention. Lists, if desired, can be printed on the spot. With the items prelisted, any purchases or returns can be readily handled by a clerk or by the customer using a kiosk portal.

### SUMMARY OF THE INVENTION

The invention includes an onsite transaction system comprising an aerial drone, having a barcode scanner and printer attachment, a smart device programmed with an onsite transaction application, and a server/cloud transaction system. The use of this system allows a customer to conduct a sale or return anywhere within a retail facility; or, if desired, at designated areas within the retail facility more efficiently—the items to be purchased or returned are prelisted. The scanning and printing functions present on the drone bring the checkout and return counters to the customer when needed. Staff involvement in menial activities is minimized and their focus can be on the customer, service and improving the purchase experience. When not in use, the aerial drones are kept in docking and/or recharging areas within the retail facility until requested by a shopper for assistance with a retail transaction. After the drone is requested, it is dispatched and follows a predetermined flight path from the docking area to the customer. Upon arrival, the drone scans the items present in the customer's cart. The drone, in cooperation with the onsite transaction application on the handheld smart device, generates sales or returns data and transmits the data to the cloud/sever transaction system. The aerial drone can also directly print a list of the scanned items as an invoice. The invoice can be presented to a store clerk for payment at a designated check out area or at a kiosk. The onsite transaction application that has been downloaded to a customer's s handheld smart device can be used by the customer to request the drone via the onsite sales application or optionally, by a gesture.

The items to be purchased or returned are present in a shopping cart. The readable bar code labels are attached to the items and can be read by the scanner present on the drone. The transaction application has the ability to distinguish by the use of code whether the items in the shopping cart is to be purchased or returned. The returns can also be physically separated from purchases and scanned separately.

The onsite transaction application provides for the following functions: store navigation and customer checkout. Additionally, the application can include an inventory management module, an identity fraud detection module, and a theft detection module. The application facilitates the transmission of information to and from the drone, as well as the point of sale system, inventory system, and fraud detection system. A drone support module is also included.

The aerial drone also includes a High Definition Video Recording Camera, which is capable of providing a live video stream, allowing surveillance of the retail store and analysis of the streamed data. The aerial drone can also include a transmitter that includes a wireless communication module, a navigation system, which includes a global positioning system (GPS), obstacle detection, and a collision avoidance module. The drone barcode scanner includes an RFID Reader Module. The printer attachment lists the scanned items as a transaction that is unique to the customer who requested the drone, and reports it as a transaction

The point of sale transaction process occurs within a retail facility and is initiated by a customer having a cart with items to be purchased or returned. The customer has downloaded a transaction application to their smartphone or other hand-held device. Based on information that is provided by the customer, the transaction application transmits identifying information to the cloud/server transaction system. The identifying information that the customer provides includes an assigned customer name or individual customer number, as well as the cart location within the retail facility, along with a 3-D map of the retail facility. The customer requests an aerial drone from the drone docking area in the retail facility. The request is transmitted from the transaction application on the customer's smartphone or other hand-held device to the cloud/server transaction system. The cloud/server transaction system determines a flight path from the drone docking area to the location of the customer/cart within the retail facility. The flight path information is directed to the drone, and the drone is then sent to the customer's exact location. When the drone arrives at the customer's or cart's location, the barcoded items contained in the cart are scanned and an item list is prepared. The list is either printed, or, if the customer desires, the list can be transmitted electronically via the transaction application to the cloud/sever transaction system. The transaction system includes a variety of modules—an inventory management module, an identity fraud detection module, and a theft detection module. These modules are supported by retail video analytics that is present in the server/cloud. Once the sales transaction has been finalized, the drone automatically returns to the docking/charging area of the retail facility. The status and availability of the aerial drones are maintained by the server/cloud transaction system.

A server or cloud based transaction system for accomplishing a point of sale drone-based transaction in a retail facility includes two or more of: a module for transmitting information to and from the drone, a point of sale system, an inventory system, a fraud detection system, a transaction system, an anti-theft and identity theft system, and an in-store navigation and customer checkout. The server/cloud transaction system maintains a database. The database includes the aerial drone's information relative to the drones that are currently in use and those that are available for use, as well as inventory data updated to reflect sales and returns. In addition, the server/cloud transaction system includes a management system which has 3 modules: a retail video analytics module, an aerial drone control module, and a shopper service module. The shopper service module coordinates drone requests, drone charging and drone availability and determines the drone's optimum flight path from the docking area to the customer based on a predetermined 3-D map of the retail facility; as well as navigation of the aerial drone along the flight path to the customer.

The scanning of items in the cart is controlled by the customer and/or the drone. The scanned items are reported via the scan printer, and that data is forwarded to the server/cloud transaction system to ensure the inventory is accurate. The server/cloud transaction system provides an inventory management system, inquiring a statistical subsystem, a personal selling system, and a system management system which analyzes the sales and return data that has been sent back to the server/cloud transaction system by the aerial drone.

The server/cloud transaction system provides a retail video module that supports an anti-theft system and identity theft system based on a video stream provided by the aerial drone camera.

### BRIEF DESCRIPTION OF THE DRAWINGS

FIG. 1 shows a frontal view of the aerial drone where a bar code scanner, camera and printer are shown along with a printed invoice and item label containing a bar code.

FIG. 2 lists components of the aerial drone (retail drone): a wireless communication module, a high definition video recording camera that has been adapted to capture the live surveillance of a retail store, a wireless communication module, and a navigation module including a global positioning system (GPS), obstacle detection, and collision avoidance. The barcode scanner of the drone includes an RFID reader module.

FIG. 3 shows an overhead view of a shopping facility with doors and shelves. The facility includes the onsite purchasing system having a retail aerial drone, a server/cloud transaction system and a handheld smart device with an onsite transaction application for communicating with the system components. Also shown is the shopper (customer) with shopping cart, the drone docking/recharging area, and the store's sensors and flight paths to and from both the docking/charging area and the location of the customer and the shopping cart (items).

FIG. 4 lists the components of the server/cloud transaction system: a module for transmitting information to and from the drone, a point of sale system, an inventory system, a fraud detection system, a transaction system, an anti-theft and identity theft system, and an in-store navigation and customer checkout. The server/cloud transaction system includes memory for a database concerning aerial drones, and updated inventory data which lists the scanned sales and returns provided by the drones. The server/cloud transaction system also provides a management system, having a retail video analytics module, an aerial drone control module, and a shopper service module. It also includes an inventory management system with an online (inquiring) statistics generating subsystem that measures individual sales data. The system management module coordinates the activities of the drones and handheld smart devices. The analytics module permits the mining of sales and return data streamed to the server cloud transaction system by the aerial drones.

FIG. 5 shows the components of the onsite transaction application that can be downloaded to the customer's handheld smart device. The onsite transaction application provides the customer with in-store navigation and customer checkout services, an inventory management module, an identity fraud detection module and a theft detection module. It shows the transmission of information to and from the aerial drone, the point of sale system, the inventory management system and the fraud detection system.

### DETAILED DESCRIPTION OF THE INVENTION

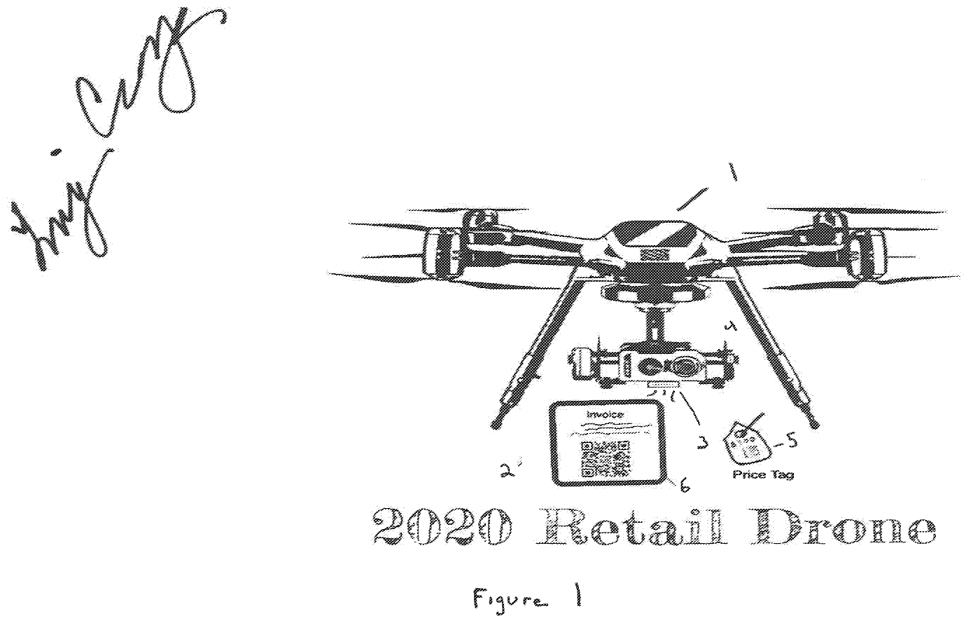

FIG. 1 shows a frontal view of the retail drone (aerial drone) (1) showing a bar code scanner (2), a printer attachment (3) and a camera (4). Also depicted is the bar code (5) of an item to be purchased or returned and a printed itemized list (invoice) (6) of the scanned items.

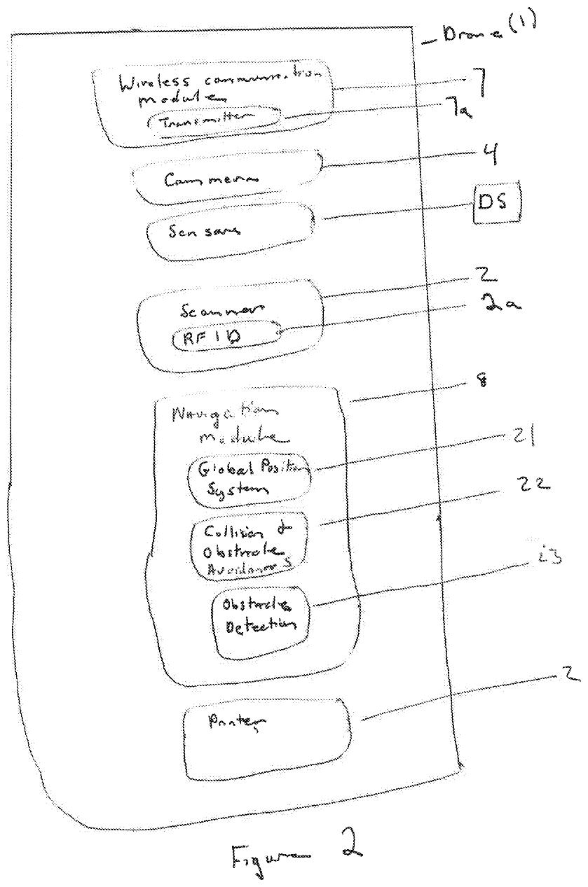

FIG. 2 lists components of the retail drone (aerial drone) (1) including a wireless communication module (7) with transmitter (7a) and navigation module (8). The printer attachment (3) and bar code scanner (2) cooperate to scan the items (9a) in the customer's cart (9) and generate an invoice (itemized list) (6) which allows the option for the customer to print and present the invoice to a sales associate at a check-out area (station) (11), or have the invoice electronically transmitted to the server/cloud transaction system (12) to access at any time. The scanned item data is sent to the server/cloud transaction system (12) and stored in memory (M). The customer can request an aerial drone (1) via a hand gesture or through the onsite sales transaction application (13) that the customer has downloaded to their handheld smart device (14) and sent via the transmitter (7a). The navigation module (8) includes a global position system (21), collision and obstacle avoidance system (22) and obstacle detection module (23). The retail drone also includes internal sensors (DS) and a camera (4).

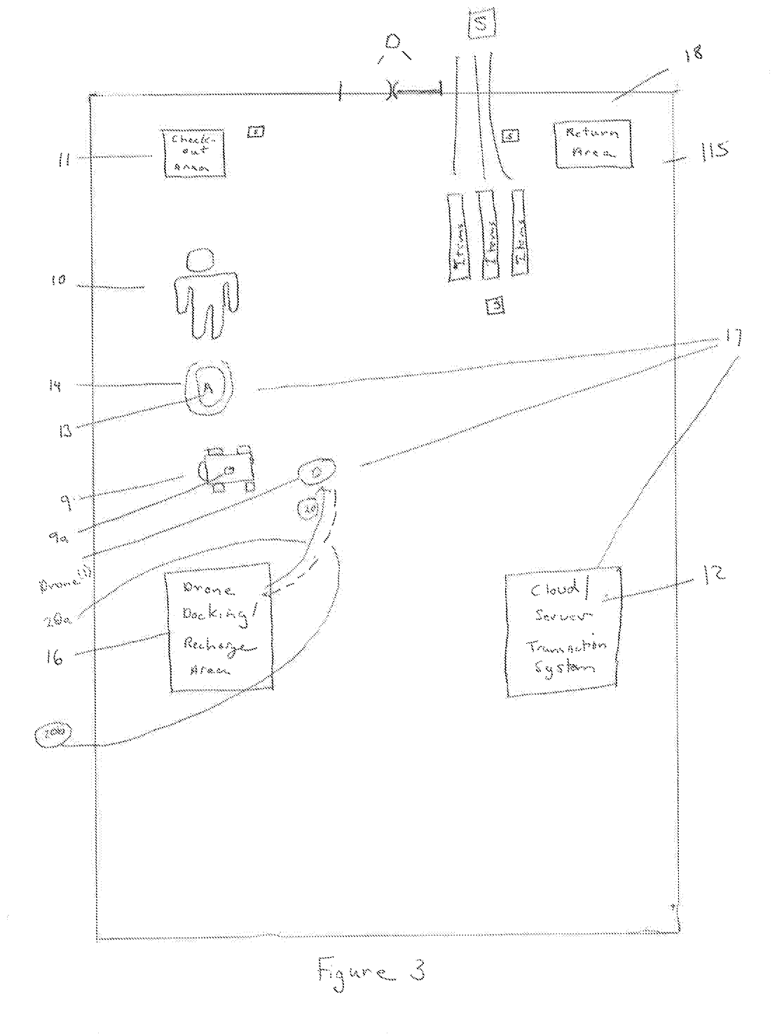

FIG. 3 shows a retail facility (15) with doors (D) and item containing shelves (S) having a drone docking/recharging area (16), sensors (RFS) and the onsite purchasing system (17) of the invention including the retail aerial drone (1), a server/cloud transaction system (12) and a handheld smart device (14) with an onsite traction application (13). Also shown is the shopper (customer) (10) with shopping cart (9) containing the items (9a) to be purchased and/or returned and flight paths (20) to and from the docking/recharging area and the customer/cart (20a, 20b). The shopper (10) and cart (9) can be located anywhere in the retail facility (15) or in designated areas—checkout (11) or return (18). The shopper (10) requests the aerial drone (1) from the drone docking/recharging area (16) using a hand gesture or, preferably, the transaction application (13) that has been downloaded to the customer's handheld smart device (14). The items (9a) to be purchased or returned are in the shopping cart (9) where the barcodes are accessible for scanner reading. The barcode scanner (2) of the aerial drone (1) proceeds to scan the barcode of each item to be purchased or returned. An item list (invoice) (6) is associated with the shopper (10). His/her identifying number is generated or obtained from memory (M). The item list (6) can be printed using the printer attachment (3) and/or transmitted to the server/cloud transaction system (12), if desired, via the transaction application (13) that is present on the customer's handheld smart device (14) to a wireless network (7a). A flight path (20) is determined by the server/cloud transaction system based on the location of the cart/customer's location and the location of the drone docking/recharging area (16) or from the location of the closest available aerial drone to the customer/cart (10, 9). After scanning the items (9a) in the cart (9), the aerial drone (1) can be returned to the docking/recharging area (16). Minor changes in the aerial drone's flight path can be made using store sensors if obstacles are present, e.g. other drones, etc. Modules for obstacle detection (23) and avoidance (22) are included in the aerial drone (1).

The drone is directed by the server/cloud via the flight path (20, 20a, 20b) to the customer. The drone deviates from the flight path (20) using the collision and obstacle module (22), if an obstacle is detected in the path by the internal sensor (23).

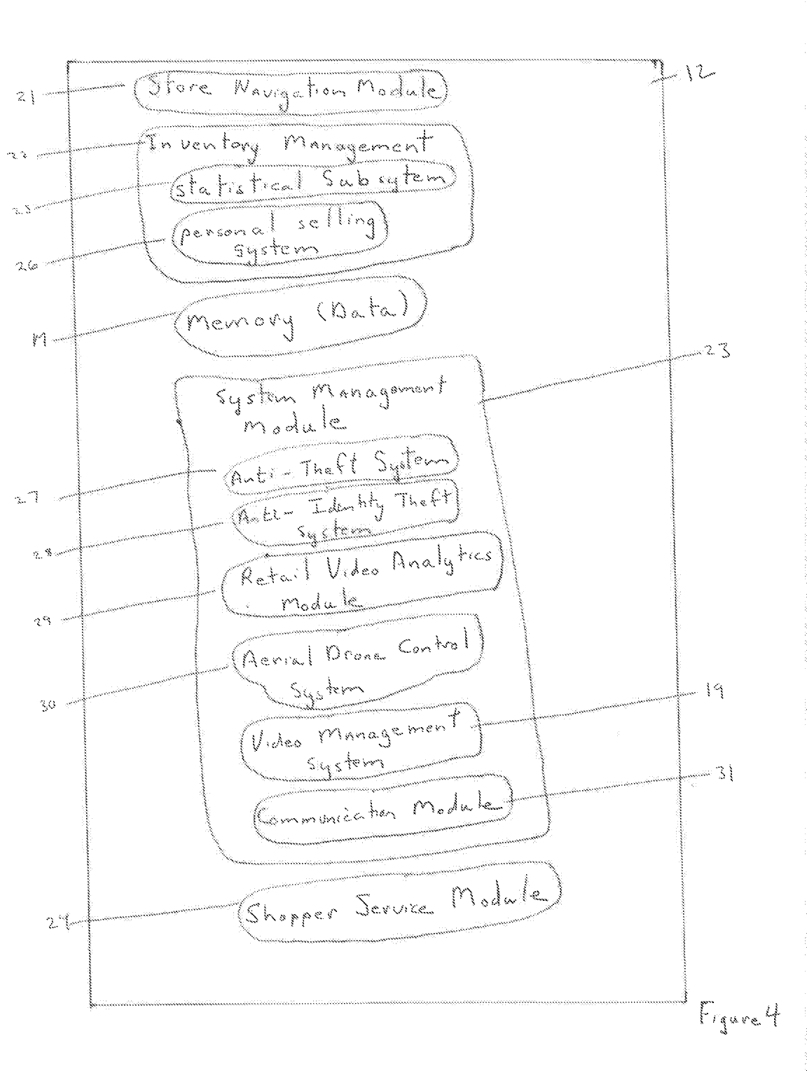

FIG. 4 shows the components of the server/cloud transaction system (12) including a Store Navigation Module (21), Memory (M), Inventory Management (22), System Management Module (23) and a Shopper Service Module (24). The Inventory Management Module (22) includes a statistical subsystem (25) and a personal selling subsystem (26). The System Management Module (23) includes Anti-theft system (27), Anti Identity Theft (28), Retail video analytics module (29), Video management system (19), and an Aerial drone control module (30).

The cloud/server transaction system (12) conducts the dispatching and directing of the aerial drone. A three dimensional map of the retail shopping facility is referenced when determining a flight path (20—20a and 20b) from the docking/recharging area (16) to the location of the requesting customer/shopping cart (10, 9). The cloud/server transaction system (12) can employ information from one or more on-board drone sensors (DS) and/or one or more installed sensors (RFS) within the retail shopping facility (15) in order to detect obstacles in the flight path (20) and take corrective measures.

A server or cloud based transaction system (12) also includes two or more of: a module for transmitting information (31) to and from the drone (1), a point of sale system (33), an inventory system (34), a fraud detection system (35), a transaction system (12), an anti-theft and identity theft system (27, 28), and an in-store navigation system (30) and customer checkout (11). The server/cloud transaction system maintains a database (M) that holds the details of the aerial drones (1) to provide aerial drone-based assistance to the customers. In addition, the server/cloud transaction system comprises a retail video analytics module (29), an aerial drone control module (30), and a shopper service module (24). The shopper service module (24) maintains a database of active and available aerial drones. The server/cloud transaction system oversees the database (M) and upon receiving a request, identifies an available drone and determines a flight path (20) from the docking/recharging area (19) to the customer based on a predetermined 3-D map of the retail facility, and navigates the aerial drone within the retail store to the customer's location. When the aerial drone arrives at the location of the customer/shopping cart, the items for purchase or return are scanned. The scan of the items can be also be facilitated by the customer. The server/cloud transaction system provides a retail video module (29) that supports an anti-theft system and identity theft system (27) that is based on a video stream provided by the aerial drone camera (4). The server/cloud transaction system provides an inventory management system (21), inquiring a statistical subsystem (25), a personal selling system (26), and system management system (23) which captures the sales and return data streamed to memory by the aerial drone (1).

Overall security is facilitated by monitoring the scanned sales and returns data from the drone (1) and the streaming video obtained by the drone camera (4). Modules of systems management system (23) provide the appropriate analytics for analysis: antitheft system (27), anti-identity theft module (28), retail video analytics module (29) and video management system (19).

The scanned return and sales data obtained from the drone (1) and the onsite transaction application is analyzed by the inventory management module (22) in particular, statistical subsystem (25) and a personal selling system (26). The inventory data present in Memory (M) is considered along the updates provided by the drones (1) and application (13) and totals kept current.

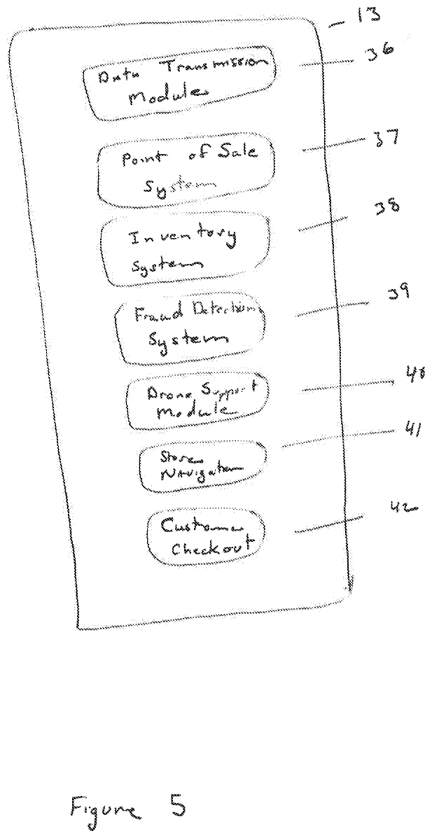

FIG. 5 list the components of the onsite transaction application (13): data transition module (36), point of sale system (37), inventory system (38), fraud detection system (39), drone support module (40), store navigation(41) and customer checkout (42), an inventory management module (43), an identity fraud detection module (44) a theft detection module (45), and a transmitter module (46). The application coordinates the activities between the transaction system cloud/server and the drone and its printer and scanner components. The sales and return data obtained by the scanner (2) is assembled by the point of sale system (37) and directed via the data transmission module (36) to the server/cloud transaction system (12). Prior to transmission the data can be analyzed by the inventory system (38) and fraud detection system (39) present in the server/cloud transaction system (12). The server/cloud transaction system signals the drone and directs its movement via the drone support module (40). The sever/cloud transaction system provides customer information relative to the layout of the store and item location through the store navigation module (41) and directs available drones to the customer via the customer checkout module (42).

Operation

Using a handheld smart device, such as a smartphone, or hand gestures, the shopper can request an aerial drone from the charging or docking area. The handheld smart device includes an application for in-store navigation assistance.

For the purposes of this invention, the aerial drone is equipped with a bar code scanner and a printer, or a printer connection. The aerial drone can also include a high-definition video recording module for capturing live surveillance video of the retail store and a wireless communication module to support communication with both the smart device application and the server/cloud. The aerial drone could additionally be equipped with a navigation module. This module can be configured by the server/cloud to navigate the aerial drone within the retail store using a 3-D map.

The navigation module includes a Global Positioning System (GPS) module to support aerial navigation in the retail store. The navigation module includes obstacle detection and a collision avoidance module, where the obstacle detection and collision avoidance module of the aerial drone includes proximity sensors, ultrasonic sensors, monocular vision sensors, infrared sensors or any other obstacle detection and collision avoidance sensors. The obstacle detection and collision avoidance modules may also include means for vision-based methods, where streaming video is analyzed for obstacle detection and collision avoidance.

Aerial drones are equipped with a camera, which may be suited for surveillance of conditions within the retail facility. The live video that is captured by the aerial drone can be streamed directly to the server/cloud, which can be adapted to run a retail video analytics module. The retail video analytics module can comprise a video management system and a video analytics module. The video analytics module can perform an automated facial expression analysis, hand gesture analysis, crowd behavior and wait time analysis, walk-through pattern analysis, engagement and conversion analysis and event based analysis to predict the emotion and behavioral patterns of the shoppers and employees. This module can support a theft detection system, as well as threat detection, suspicious activity detection and the ability to offer personalized customer recommendations. The video analytics module on the server/cloud also generates information concerning shopper related intelligence, traffic related intelligence, retail store related intelligence and product related intelligence, which will identify and improve the retail store performance and enhance the customer's shopping experience.

The server/cloud transaction system manages the shopper's requests for aerial drone assistance, assigns free aerial drones to provide service for the shopper and also assigns aerial drones for live video surveillance of the retail store. The aerial drone control module on the server/cloud transaction system also controls the flight path of the aerial drones in the retail store by communicating with the aerial drone's GPS modules. The aerial drone control module on the server/cloud transaction system also supports obstacle detection and collision avoidance of aerial drones during their flight in the retail store either by using the obstacle detection and collision avoidance module equipped on the aerial drones, or by using the vision-based methods with the help of the video analytics module. The shopper service module on the server/cloud transaction system provides services to the shopper to support smart shopping, online billing and payment, and unassisted self-checkout, along with a personalized recommendation system and an in-store navigation system through the transaction application that has been downloaded to the shopper's handheld smart device. The server/cloud transaction system maintains the database to store all the relevant information regarding the retail store, the shopper, inventory, billing and payment information, and warehouse pickup points. The communication between the transaction application, the aerial drone and the server/cloud transaction system can be made through any type of wireless communications network, such as a Local Area Network (LAN) or a Wide Area Network (WAN), or through any Internet Service Provider (ISP).

While the invention has been described with an emphasis on preferred embodiments, it will be obvious that variations of the preferred embodiments may be used, and that it is intended that this invention may be practiced otherwise than as specifically designed herein. Accordingly, this invention includes all modifications encompassed within the spirit and scope of the invention as defined by the following claims.

1. In an aerial drone having a camera, means for navigation and transmitter, wherein the improvement comprises a barcode scanner and printer attachment to record a sales or return transaction, permitting customer self-checkout and inventory management through a server/cloud transaction system where the scanner reads barcodes of items in a cart, the printer attachment lists the scanned items as a transaction, and the drone reports the transaction to the server/cloud transaction system.

2. The aerial drone of claim 1, wherein the camera is a high definition video recording camera that has been adapted to capture and stream live surveillance of a retail store.

3. The aerial drone of claim 1, wherein the transmitter includes a wireless communication module.

4. The aerial drone of claim 1, wherein the navigation module includes a global positioning system (GPS), obstacle detection, and a collision avoidance module.

5. The aerial drone of claim 1, wherein the barcode scanner includes an RFID Reader Module.

6. A process for a point of sale transaction within a retail facility that is initiated by a customer with a cart comprising,
requesting the aerial drone according to claim 1 from a drone docking area within the retail facility,
transmitting customer information including location and identifier to a cloud/server transaction system,
determining a flight path from the drone docking area to the customer with a cart,
transmitting to the drone the flight path from the drone area to the location of the customer with a cart having items to be scanned,
releasing the drone to proceed along the flight path to the customer with the cart,
preparing a list of the items in the cart using the drone scanner and transmitting the list to the printer or the server/cloud transaction system, where inventory status is updated and customer identity is verified,
finalizing the purchase of the point of sale transaction and
returning the aerial drone to the drone area along the flight path.

7. The process of claim 6, wherein the transaction system provides inventory management, identity fraud detection, and theft detection.

8. The process of claim 7 wherein the anti-theft system and identity theft detection is supported by retail video analytics present in the server/cloud transaction system.

9. The process of claim 6, wherein the availability and status of the aerial drone is maintained by the server/cloud transaction system and facilitates assistance to the shoppers.

10. The process of claim 6, where the aerial drone provides video and customer information to the server/cloud transaction system that includes retail video analytics and aerial drone control, and shopper service modules to facilitate customer service.

11. The process of claim 6, wherein the release and return of the aerial drone is controlled by the server/cloud transaction system.

12. The process of claim 6 wherein the request includes the use of a handheld smart device, or a hand gesture.

13. The process of claim 6 wherein the inventory status includes inquiring a statistical subsystem, a personal selling system, and system management system.

14. A server or cloud based system accomplishing a point of sale transaction within a retail facility involving one or more drones of claim 1, where the drone is summoned by a shopper to a location where a shopping event has been concluded, and desired items are present in a cart where the system includes two or more of: a module for transmitting information to and from the drone, a point of sale system, an inventory system, a fraud detection system, a transaction system, an anti-theft and identity theft system, and an in-store navigation and customer checkout option.
